(19) United States
(12) Patent Application Publication
(10) Pub. No.: US 2005/0135271 A1
(43) Pub. Date: Jun. 23, 2005

(54) Network information setting method, network system and communication device

(76) Inventors: Atsushi Inoue, Kawasaki-shi (JP); Nobuo Okabe, Musashino-shi (JP); Masahiro Ishiyama, Kawasaki-shi (JP); Shoichi Sakane, Musashino-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/969,010

(22) Filed: Oct. 21, 2004

(30) Foreign Application Priority Data
Oct. 28, 2003 (JP) 2003-368037

(51) Int. Cl. H04L 12/28

(52) U.S. Cl. 370/254

(57) ABSTRACT

Property information of a communication device is initialized in a second server when the communication device is connected to a control network to which a first server for storing key information and a second server for storing property information are connected. Key information necessary for security communication with respect to the second server is acquired from the first server and property information containing at least an identifier and network address of the communication device is transmitted to the second server via security communication using the key information.

### CROSS-REFERENCE TO RELATED APPLICATIONS

This application is based upon and claims the benefit of priority from prior Japanese Patent Application No. 2003-368037, filed Oct. 28, 2003, the entire contents of which are incorporated herein by reference.

### BACKGROUND OF THE INVENTION

1. Field of the Invention

The present invention relates to a network information setting method, network system and communication device in an IP-based control network.

2. Description of the Related Art

The control network technique used in a building network or FA (Factory Automation) network starts to be provided at substantially the same time as the Internet which is rapidly popularized in recent years. However, it is developed according to its own line based on the particular condition such as the restriction on cost. Most of the control network techniques have protocol hierarchies which are based on the proprietary technique different from the Internet technique. Further, the control network technique which takes part of the Internet technique such as TCP or UDP into the transport layer is provided. For example, BACnet (trade mark) and MODBUS TCP/IP (trade mark) are provided as typical examples. They are called as IP-based control networks.

The thus IP-based control network is not open to the public and is closed so far. Since its own protocol is used, less interest is given to the security thereof from the beginning. However, if the control network and the Internet are connected to each other, it becomes important to attain the high security. Even if the control network has its own protocol and it is not open to the public, it is impossible to effectively protect the network against the attack by a malicious third party having explicit ill will. A packet flows on or above the public space if the Internet is provided between the control networks when the control system is dispersed to configure a wide-area control network environment. Therefore, it is impossible to assume a closed network. Further, even if a closed network is configured when the wireless technique is used in a layer 2, there occurs a possibility that the third party takes advantage of the laxness of the security of the radio layer and easily accesses the network. However, in order to effectively utilize the Internet technique, it is impossible to assume the particular layer-2 technique. Therefore, the security technique depending on the particular layer 2 narrows the width of selection of the system configuration and increases the engineering cost. As a result, it is desired to provide a security method which does not depend on the particular layer 2.

At present, network information setting which permits devices to be operated on the control network is manually and statically made. It is inefficient to manually set information necessary for the operation with respect to a large number of devices distributed on the control network. Further, it may cause errors. The peripheral devices of the field devices are limited. In addition, the possibility that the types of the peripheral devices which can be used according to the devices are different is high.

### BRIEF SUMMARY OF THE INVENTION

When a device is connected to a control network and the control network is configured, it is desired to safely and autonomously set up the device instead of manually setting the device. This is because it does not take a lot of time for setting even if a large number of devices are connected to the control network and it becomes possible to easily configure the control network which is widely arranged in a large space.

Therefore, the present invention is directed to provide a network information setting method, network system and communication device which permit a safe and autonomous setup of devices connected to a control network.

According to embodiments of the present invention, property information of a communication device is initialized in a second server when the communication device is connected to a control network to which a first server for storing key information and a second server for storing property information are connected. Key information necessary for security communication with respect to the second server is acquired from the first server and property information containing at least an identifier and network address of the communication device is transmitted to the second server via security communication using the key information.

### BRIEF DESCRIPTION OF THE SEVERAL VIEWS OF THE DRAWING

FIG. 1 is a block diagram showing a network system according to a first embodiment of the present invention;

FIG. 2 is a block diagram showing a communication device according to the first embodiment of the present invention;

FIG. 3 is a diagram showing a message sequence which is used to perform a setup (initialization) in the first embodiment of the present invention;

FIG. 4 is a diagram showing a message sequence used when communication is made between entities in the first embodiment of the present invention;

FIG. 5 is a view showing a control network system according to a second embodiment of the present invention;

FIG. 6 is a diagram showing the outline of a message sequence (at the startup stage) according to the second embodiment of the present invention;

FIG. 7 is a diagram showing the outline of a message sequence (at the discovery (detection) stage) according to the second embodiment of the present invention;

FIG. 8 is a diagram showing a message communication sequence for searching for a Kerberos KDC using DHCP;

FIG. 9 is a diagram showing a message communication sequence for authentication of the Kerberos KDC;

FIG. 10 is a diagram showing part of a message communication sequence for searching for a property server;

FIG. 11 is a diagram showing another part of the message communication sequence for searching for the property server;

FIG. 12 is a diagram showing another part of the message communication sequence for searching for the property server;

FIG. 13 is a diagram showing part of a message communication sequence for registering self information;

FIG. 14 is a diagram showing another part of the message communication sequence for registering the self information;

FIG. 15 is a diagram showing another part of the message communication sequence for registering the self information;

FIG. 16 is a diagram showing a message communication sequence for acquiring startup information;

FIG. 17 is a diagram showing a message communication sequence for acquiring an address of a communication partner;

FIG. 18 is a diagram showing part of a message communication sequence for desired communication;

FIG. 19 is a diagram showing another part of the message communication sequence for desired communication;

FIG. 20 is a diagram showing another part of the message communication sequence for the desired communication;

FIG. 21 is a diagram showing a protocol stack according to an example of application to BACnet (trade mark) in the present invention; and

FIG. 22 is a diagram showing a protocol stack according to an example of application to MODBUS TCP/IP (trade mark) in the present invention.

### DETAILED DESCRIPTION OF THE INVENTION

There will now be described embodiments of the present invention with reference to the accompanying drawings.

### First Embodiment

A first embodiment of the present invention relates to a network system which realizes automatic control (monitoring/controlling devices for production, prevention of disaster damage, illumination control and the like) in a plant or building. For automatic control, the system includes a subsystem having a plurality of devices. The subsystem devices corresponding to a monitoring system, data logger, sensor/actuator group are physically or logically widely arranged in a facility, connected to a control network and operated. As the control network, a network may be realized based on existing BACnet (trade mark), MODBUS (trade mark) or an IP network can be newly configured. It is preferable to use IPv6 in the IP network. It should be noted that the present invention is not limited to the application to the network system for automatic control in the plant or building.

The network system of this embodiment realizes an autonomous setup which makes unnecessary manual and troublesome information setting for a group of devices connected to the IP-based control network. In order to safely perform the information setting, security is taken into consideration. That is, a configuration is provided which can make it possible for devices adequately authenticated by a system to acquire necessary data from an adequately authenticated server.

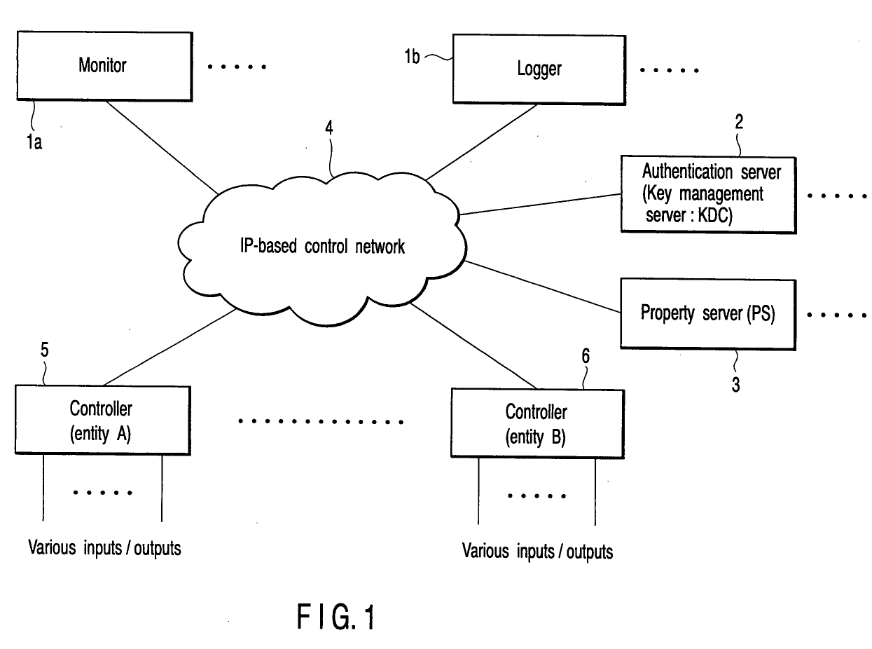

FIG. 1 is a block diagram showing a network system according to the first embodiment of the present invention. A group of devices such as a monitor 1a, logger 1b and controllers 5, 6 are connected to an IP based control network 4. A KDC 2 and property server 3 are also connected to the IP based control network 4. The service or device lying on the IP based control network 4 is called an “entity”. In this case, one device corresponds to one node. Further, a node having a single function of providing just one service corresponds to one entity, but there is provided a node such as a server which provides a plurality of services. In this case, the individual service corresponds to one entity. That is, one node can configure a plurality of entities.

In the following explanation of the specification, a term “node” indicates an object as a device connected to the IP based control network 4 and a term “entity” indicates a node which is an object to be authenticated.

For communication between entities, security can be attained by mutual authentication by use of the KDC 2 shown in FIG. 1. The KDC 2 is a first server which authenticates a substance (identifier) of the entity and issues key information necessary for making security communication between the entities when mutual authentication is successfully made between a plurality of entities. It is called an authentication server or key management server. The definition of the KDC is concretely described in a reference document, i.e., C. Kaufman, R. Perlman, M. Spenciner, “Network Security”, Prentice Hall, Section 7.7.1, which is incorporated herein by reference. For example, if the KDC 2 authenticates an identifier of a certain entity, it ensures authentication of the identifier for other entities.

A plurality of entities which authenticate one another protect communication safety by use of a key commonly obtained as the authentication result. For the communication safety, for example, it is possible to utilize IPsec which is the security of the IP layer.

In the network system of the embodiment, it is necessary to provide the following services (1) to (3).
(1) Service which provides information necessary for permitting each entity to communicate with KDC For example, the service can be attained by causing the entity to transmit a KRB_AS_REQ message in a multicast fashion and causing DHCP to transmit KDC information. An example of the configuration in which a DHCP server giving a DHCP service is provided is explained in a second embodiment.
(2) Property information providing service which provides property information relating to resource necessary for autonomously operating each entity on network In order to realize the above service, the property server (PS) 3 shown in FIG. 1 is used. The property server 3 is a second server which provides property information relating to the resource.

The property information contains at least information (identifier and network address) necessary for mutual authentication of entities. That is, each entity can register its own information into the property server 3 and retrieve information of another entity from the property server 3.

When IP addresses of the devices are dynamically distributed by DHCP or the automatic address configuration of IPv6, the identifiers and IP addresses may not be previously statically set to correspond to one another. Even in this case, a necessary IP address can be acquired by retrieval from the property server 3.

Further, it is preferable to efficiently make parameter setting by registering information other than the information necessary for mutual authentication, for example, a function list which the entity has into the property server 3 as an option.
(3) Service which provides property server information required for each entity to make communication with property server For example, the KDC 2 may provide property server information. Alternatively, the property server information can be transmitted from the DHCP server.

In the network system of the embodiment, each node has the function explained below. That is, a communication device corresponding to a certain node detects the KDC 2 on the IP based control network 4 and makes mutual authentication by use of a key provided by the KDC 2. Further, it detects the property server 3 on the IP based control network 4 and makes mutual authentication between the node and the property server 3 by use of the KDC 2. Further, information of the node can be registered into the property server 3 and an inquiry can be issued to the property server 3 in order to acquire information of another node. Then, the node makes mutual authentication with respect to the other node by use of the KDC 2 and acquires a safe communication path.

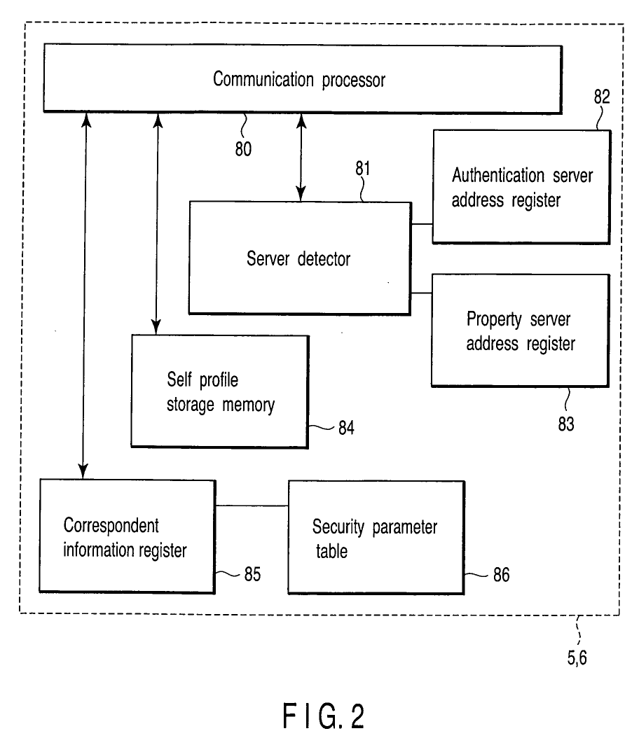

FIG. 2 is a block diagram showing a communication device connected to the control network system according to the first embodiment of the present invention. As shown in FIG. 2, the communication device includes a communication processor 80, server detector 81, authentication server address register 82, property server address register 83, self profile storage memory 84, communication partner information register 85 and security parameter table 86.

The server detector 81 detects the authentication server (KDC) 2 and property server 3 by use of a certain network service (for example, DHCP, multicast) in the IP based control network 4. The IP addresses of the detected servers are stored in the authentication server address register 82 and property server address register 83.

In the self profile storage memory 84, profile data indicating the node name (identifier), IP address, function and the like of the communication device is stored. At least the node name and IP address are stored in the self profile storage memory 84. As registration data into the property server 3, desired information which is different from the above data and relates to the device property may be stored. By registering minimum necessary data which is required to get information on the configuration of each node into the property server 3, it becomes unnecessary to hard-code network connection information indicating how to make a connection to a selected node and control information indicating the operation mode for each node.

In the communication partner information register 85, property information of a node (entity) of a desired communication partner obtained as the result of inquiry made at the property server 3 about the node is stored. Further, a security parameter (containing a cipher key) which is exchanged with respect to the communication partner via the authentication server (KDC) 2 is stored into the security parameter table 86. Thus, communication supported by the security is set up between the nodes by use of the security parameter.

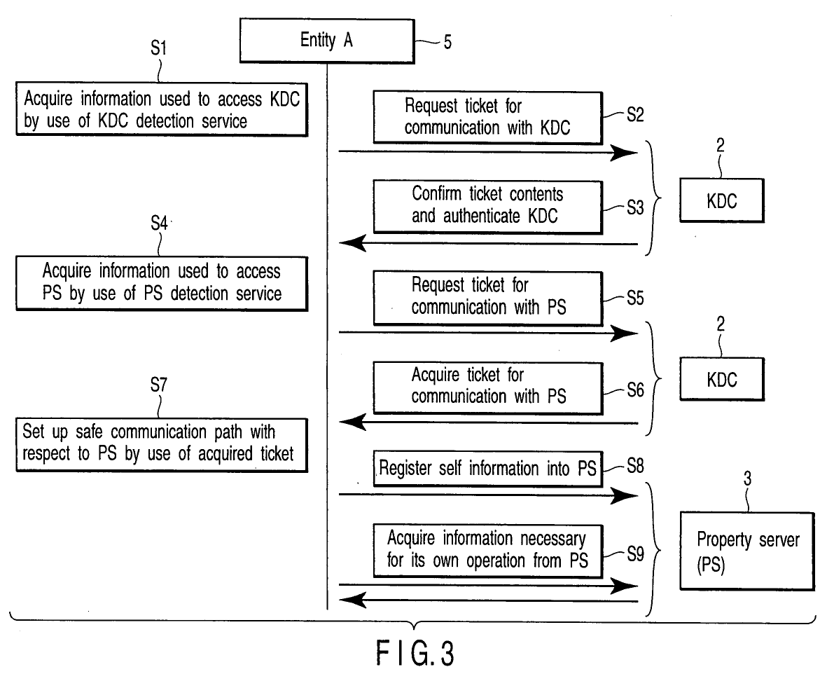

When each entity is connected to the IP based control network 4, an autonomous setup (initialization) is made by use of the KDC 2 and property server 3 according to the following message sequence. The message sequence schematically includes (1) detection and authentication of KDC, (2) detection of property server (PS), (3) registration of self information and (4) acquisition of setup information. Next, the message sequence is explained in detail with reference to FIG. 3. The sequence is made for setup of the entity A (controller 5 shown in FIG. 1).

As shown in FIG. 3, information used to access the KDC 2 is acquired by use of a KDC detection service (step S1). Next, a request for a ticket used to communicate with the KDC 2 is issued to the KDC 2 according to the information acquired in the step S1 (step S2). In this case, the ticket indicates information used by two entities which are placed under control of the KDC to make mutual authentication. The KDC which issues a ticket stores confidential information of all of the entities which issue tickets for authentication. Only the KDC can form a ticket for authentication of the entity. The KDC 2 is authenticated by confirming the contents of the issued ticket (step S3). At this time, communication with the KDC 2 in the steps S2 and S3 is protected by security provided by the KDC 2.

Next, information for accessing the property server 3 is acquired by use of the property server detection service (step S4). Then, a request for a ticket used to communicate with the property server 3 is issued to the KDC 2 according to the information acquired in the step S4 (step S5). After this, a ticket for communication with the property server 3 is acquired (step S6). At this time, communication with the KDC 2 in the steps S5 and S6 is protected by security provided by the KDC 2.

Next, a safe communication path with respect to the property server 3 is set up by use of the acquired ticket (step S7). After this, communication between the entity A and the property server 3 is protected by security.

Then, information (address, identifier and the like) of the entity A is registered into the property server 3 (step S8). Further, information necessary for the network operation of the entity A is acquired from the property server 3 (step S9). The same process is performed for the other entities.

As information which is registered into the property server 3, an IP address and name information used for mutual authentication by the entity A are necessary as described above. Further, desired optional information other than the above information may be registered. For example, if information containing a function list is registered, it is possible to search for an entity which can provide a particular service or an entity which can be controlled by a certain terminal. More specifically, as information registered into the property server 3, the following information can be assumed, for example:

Identifier and IP Address of Each Node

The registration process of the above information is desired in the embodiment of the present invention and each node registers its own identifier and a dynamically allocated IP address into the property server 3. When the other entity accesses the above node, a partner node identifier is given to the property server 3 and an adequate IP address corresponding to the partner node identifier can be acquired.

Location Information of Each Node

If each node can acquire its own location information by use of a certain method, it registers the location information into the property server 3. The monitoring system can dynamically form a physical map of all of the nodes under monitoring by acquiring the location information from the property server 3. Another advantage of this method is to permit the monitoring system to autonomously cope with a variation in the setting position of the node. Since the location information of the node is statically set in the conventional monitoring system, it takes a lot of time to set location information when a large number of nodes are provided and it is impossible to automatically cope with a variation in the position of the node when the position of the node is changed.

Manufacturing Information of Each Node

Each node registers its own manufacturing information (maker name, model number, version number and the like) into the property server 3. The system administrator can easily attain adequate maintenance and management (repair, exchange, update and the like) by reading out the manufacturing information of all of the nodes from the property server 3 and thus attain the stability and low cost of the system operation.

Access Control Information of Each Node

The system administrator collectively manages the authorization of each node by use of the property server 3. When a certain node is accessed by another node, it acquires the authorization of the partner node from the property server 3 and compares the authorization with a requested service. If the request exceeds the authorization, the node refuses the request of the partner node. In the embodiment of the present invention, since the reliable property server 3 is configured to collectively manage the authorization of each node, safe and efficient access control can be realized and a safe system can be provided.

Control Parameters of Each Node

The system administrator collectively manages control parameters necessary for the operation of each node by use of the property server 3. The node acquires its own control parameters from the property server 3 after starting the operation and then starts the actual control operation. When the actual system is configured in the prior art, it is necessary to previously set the control parameters in each node. When the control parameters of the node are changed after the node is actually installed, the following problems occur in the prior art. That is, (1) a special tool is necessary in some cases, (2) it is necessary to previously set a special wiring so as to change the setting, (3) the operation of a portion or whole part of the system may be temporarily interrupted in some cases, and (4) means for changing the setting on the online itself may cause a problem on safety. On the other hand, the embodiment of the present invention utilizes the property server 3 for setting and changing the control parameters. Therefore, it is excellent because the special tool and wiring are not necessary, the process can be performed without interrupting the operation of a portion or whole part of the system and the safety of communication is taken into consideration.

After registration of the self information of all of the entities into the property server 3 is completed, a desired one of the entities can detect the partner entity via the property server 3 and set up a safe communication path via the KDC 2.

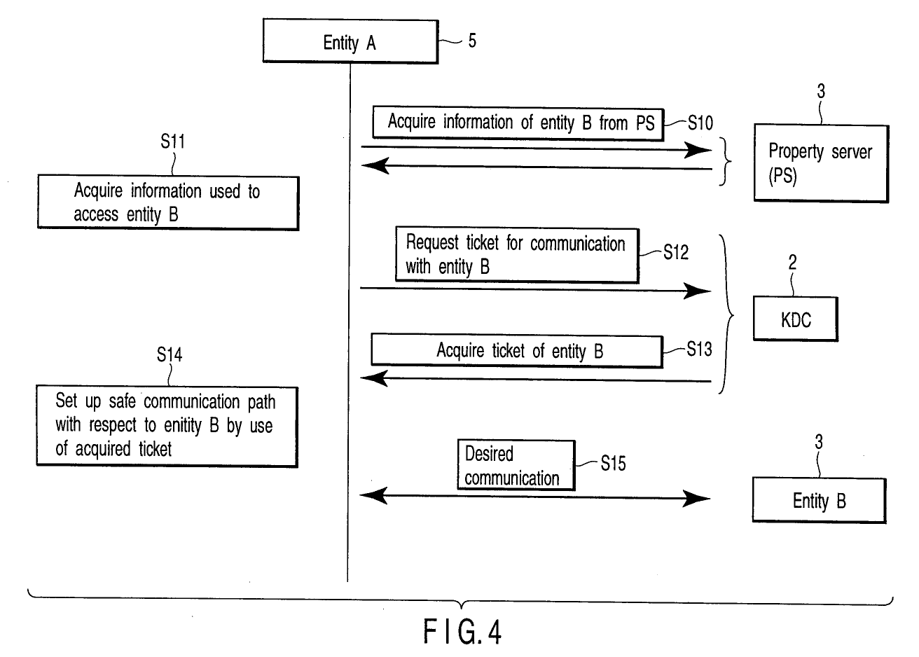

FIG. 4 shows a message sequence used when communication is set up between entities A and B. First, the entity A inquires of the property server 3 about information of the partner entity B with which it desires to communicate based on the identifier of the entity B (step S10). In the property server 3, an IP address of the entity B is acquired based on the identifier of the entity B and informed to the entity A.

Next, a request for a ticket for making communication with the entity B is issued to the KDC 2 (step S12). When a ticket of the entity B is acquired (step S13), a safe communication path between the entity A and the entity B is set up by use of the thus acquired ticket (step S14). After this, communication with the entity B is protected and desired communication between the entities A and B is made (step S15).

According to the first embodiment of the present invention described above, a safe and autonomous setup operation of the device connected to the control network can be attained. Further, it has the following merits. That is, only a pair of entities which are mutually authenticated can set up communication in the control network and security which ensures consistency and confidentiality of communication between the entities can be attained in an end-to-end fashion.

A certain entity can flexibly specify the condition to detect one partner or a plurality of partners and protect the privacy of the contents of communication made in the course of the detection process mainly on the device searching side.

Further, a setup in which an adequately authenticated entity acquires information necessary for the operation on the control network from the adequately authenticated server can be realized. At this time, information acquired from the server can be freely specified on the entity side and the privacy of the contents of communication made during the above process can be protected.

Further, by registering and collectively managing property information such as the name, IP address, function and the like of each node in the property server 3, transfer of communication parameters between the corresponding nodes can be automatically made without a manual operation even when the configurations of a large number of nodes installed in a building or factory, for example, are changed according to redecoration of the rooms of the building or rearrangement of the lines in the factory, for example. Therefore, the management cost for the whole control network can be suppressed to an extremely low cost.

In the future, the control network and a communication network such as the Internet may be adequately combined to provide services such as entrance/exit management by use of RF tags and control of a facility network device using IP terminals such as PC and PDA, for example. Since the embodiment of the present invention has an extremely greater affinity for the IP terminal and can be provided together with the control network which is conventionally operated, it is advantageous in the installation cost and the like.

### Second Embodiment

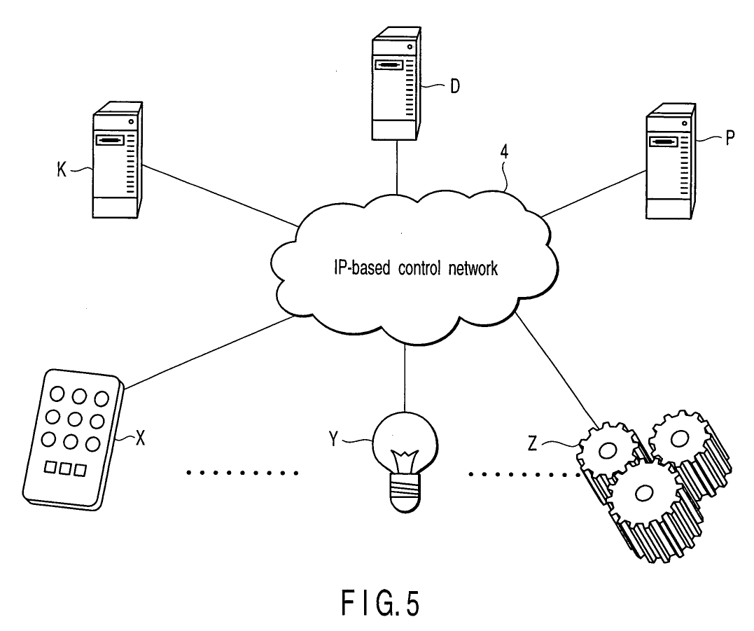

The second embodiment of the present invention is more concrete than the first embodiment described above. FIG. 5 is a view showing a network system according to the second embodiment of the present invention. In the second embodiment, IPv6 is applied. Further, Kerberos is used for mutual authentication of devices, DHCP is used for detection of a KDC which is a key distribution server of Kerberos and IPsec is used for safety of communication between entities. In addition, KINK is used for dynamic key exchange necessary for the operation of IPsec.

Kerberos is a communication protocol which is defined by RFC1510. Kerberos provides a service to permit the entity on the network to make mutual authentication by use of the identifier. In this case, a term “identifier” does not indicate an IP address but indicates a name. In Kerberos, the substance of a device (entity) is referred to as a “principal”. Further, a logical area under management of certain Kerberos is referred to as a “realm”. The realm has a name which is a realm name. A principal belonging to a certain realm has a name which is a principal name. Therefore, the identifier of the principal is configured by a combination of the principal name and realm name.

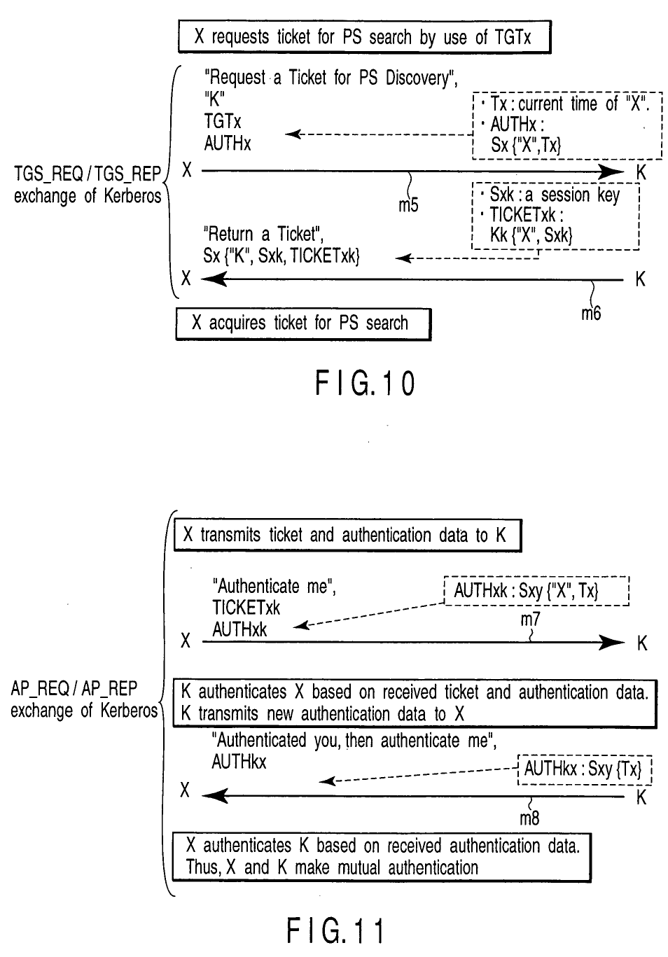

The KDC which is a server of Kerberos commonly has confidential information with each device. The Kerberos KDC collectively manages confidential information of all of the devices and provides mutual authentication between entities by use of a service of “ticket”. The mutual authentication between the device utilizing the ticket and the Kerberos KDC will be described later (refer to AS_REQ/AS_REP exchange of FIG. 9). Further, mutual authentication between entities utilizing the ticket will be described later (refer to TGS_REQ/TGS_REP exchange and AP_REQ/AP_REP exchange of FIG. 10).

DHCP is a communication protocol defined by RFC2131 and is a protocol used to permit the device connected to the network to detect the resource on the network. The device connected to the network broadcasts a DHCP request onto the network. The DHCP server on the network detects the broadcasted request and notifies the network resource (for example, IP address of the DNS server, IP address which can be used by the device and the like) which it knows. Since the DHCP protocol itself does not have an authentication function, it is possible to deceive the DHCP server.

IPsec is a communication protocol defined by RFC2401 and provides security for a packet of an IP layer. IPsec provides a function of enciphering a payload of the IP packet and a function of preventing falsification of the IP packet. In order to permit both ends which make communication to make communication protected by IPsec, they have to commonly have confidential information which is called security association (SA). A method for commonly providing information relating to SA is called a key exchange method. As the key exchange method, a manual static exchange method and dynamic exchange method by use of a key exchange protocol are provided. When the convenience at the time of actual operation is taken into consideration, the dynamic exchange method by use of the key exchange protocol is useful.

KINK is a key exchange protocol for IPsec obtained in the course of standardization in IEFT at present. In KINK, both ends which set up IPsec exchange information relating to SA by use of a mutual authentication service of Kerberos.

In the KINK-based authentication platform described above, each entity corresponding to the IPv6 node safely makes the autonomous setup and detects partner device according to a message sequence which will be described below.

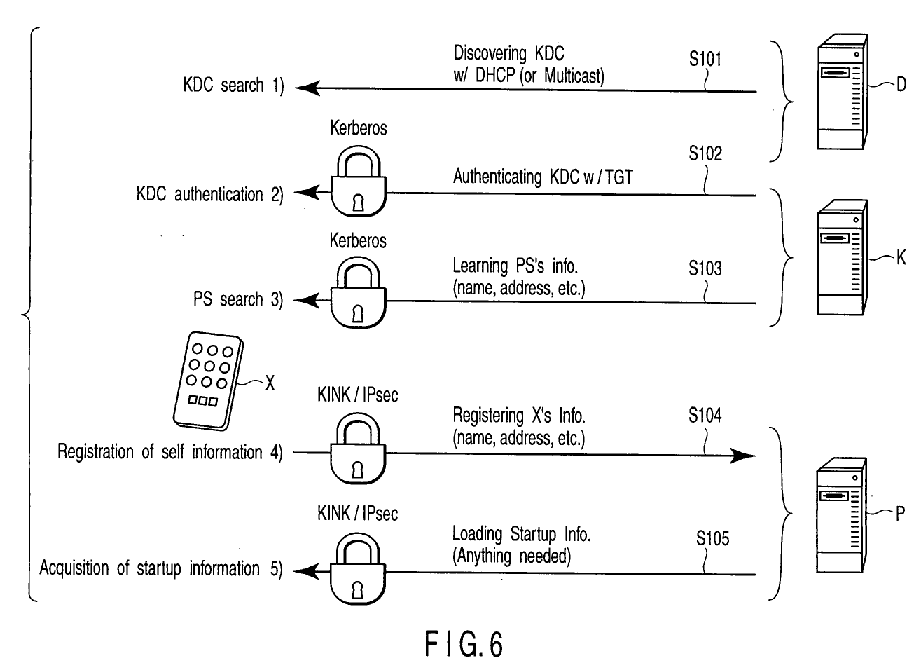

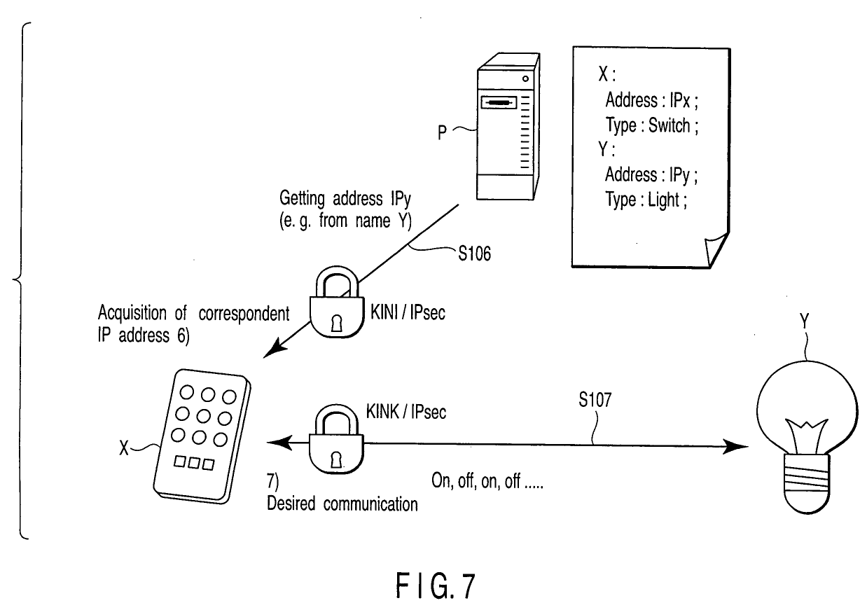

FIGS. 6 and 7 are diagrams each showing the outline of a message sequence according to the second embodiment of the present invention. The message sequence is roughly divided into a message sequence at the start-up stage of FIG. 6 and a message sequence at the discovery (detection) stage.

As shown in FIG. 6, at the start-up stage, first, a switch (“X”) is used to search for a Kerberos KDC (“K”) existing on the IP based control network 4 via a DHCP server (“D”) to acquire the information (specifically, IP address) (step S101). Generally, the identifier of the Kerberos KDC is fixed and it is not necessary to obtain the same from the DHCP server (“D”). Next, since it is not ensured that information of the Kerberos KDC acquired from the DHCP server (“D”) is correct, it is required to authenticate the correct Kerberos KDC. At this time, a reliable Kerberos KDC (“K”) is selected by AS_REQ/AS_REP exchange of Kerberos (step S102). After this, information of the property server (“P”) (identifier and IP address) is acquired from the reliable Kerberos KDC (“K”) (step S103). It is considered that the information of the property server (“P”) acquired from the reliable Kerberos KDC (“K”) is reliable. Then, self information (identifier and IP address) of the switch (“X”) is registered into the property server (“P”) (step S104).

When the switch (“X”) which is a node sets up communication with the property server (“P”), mutual authentication is made by use of Kerberos and communication is protected by use of IPsec, and therefore, it is considered that the property server (“P”) as the substance can be relied it is considered that the property server (“P”) as the substance can be relied. Further, the property (“P”) may rely on the switch (“X”) for the same reason. Then, the switch (“X”) acquires startup information necessary for the operation thereof from the property server (“P”) (step S105).

As shown in FIG. 7, at the discovery (detection) stage, the switch (“X”) first acquires information (identifier and IP address) of a communication partner by use of the reliable property server (“P”). In this case, it is assumed that an illumination device (“Y”) which is a device (node) connected to the IP based control network 4 is a communication partner (step S106). Further, it is assumed that information of the partner, that is, information of the illumination device (“Y”) acquired from the property server (“P”) is reliable since the property server (“P”) is reliable. Then, the switch (“X”) makes desired communication with the illumination device (“Y”) which is a partner device (step S107). When the communication is set up, mutual authentication is made by use of Kerberos and the communication is protected by use of IPsec. Therefore, it can be considered that the illumination device (“Y”) which is a partner as a substance is reliable. At this time, the illumination device (“Y”) treats the switch (“X”) as a reliable device for the same reason.

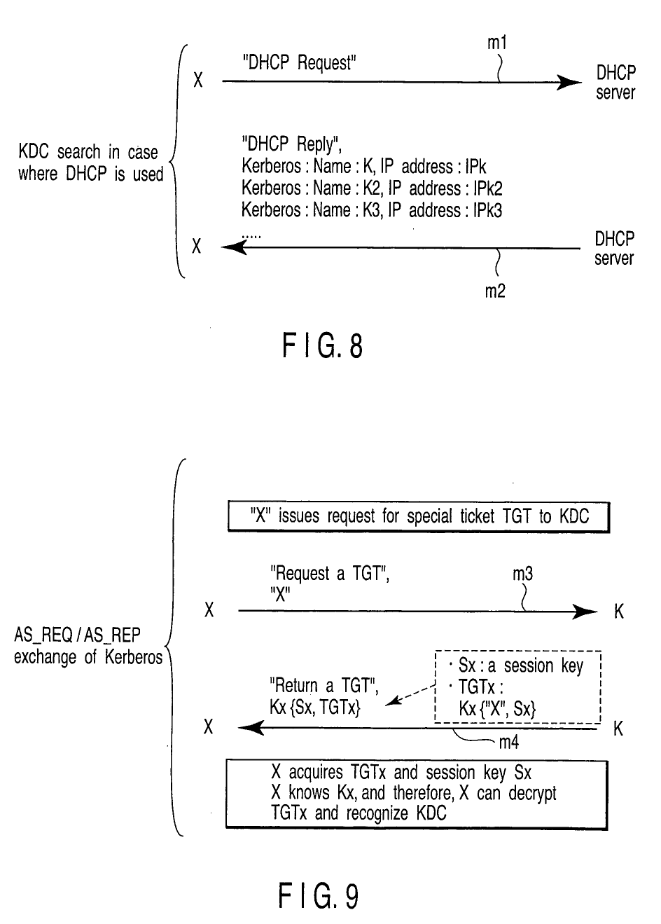

The message sequence explained with reference to FIGS. 6 and 7 is explained in more detail with reference to FIGS. 8 to 20. In this case, it is assumed that DHCP is used to search for the Kerberos KDC.

(Step S101: Search for Kerberos KDC by Use of DHCP)

As shown in FIG. 8, in the searching process for the Kerberos KDC by use of DHCP, a message m1 (“DHCP Request”) is transmitted from the switch (“X”) to the DHCP server. In response to the message, the DHCP server returns a message m2 (“DHCP Reply”, Kerberos: Name: K, IP address: IPk, Kerberos: Name: K2, IP address: IPk2, Kerberos, Name: K3, IP address: IPk3, . . . ).

(Step S102: Authentication of Kerberos KDC)

As shown in FIG. 9, in the AS_REQ/AS_REP exchange process of Kerberos, the switch (“X”) transmits a message m3 which requests a special ticket TGT to the Kerberos KDC (“K”). The switch (“X”) acquires TGTx and session key Sx based on a message m4 supplied thereto as a reply. At this time, since the switch (“X”) knows Kx, it can decipher TGTX and thus authenticate the Kerberos KDC (“K”)

(Step S103: Search for Property Server)

As shown in FIG. 10, in the TGS_REQ/TGS_REP exchange process of Kerberos, the switch (“X”) transmits a message m5 which requests a ticket for searching for the property server to the Kerberos KDC (“K”) by use of TGTX. The switch (“X”) receives a message m6 as a reply from the Kerberos KDC (“K”) and acquires the ticket for searching for the property server.

Next, as shown in FIG. 11, in the AP_REQ/AP_REP exchange process of Kerberos, the switch (“X”) transmits a message m7 which contains authentication data and a ticket to the Kerberos KDC (“K”). The Kerberos KDC authenticates the switch (“X”) based on the received ticket and authentication data and transmits a message m8 containing new authentication data to the switch (“X”).

In response to the message, the switch (“X”) authenticates the Kerberos KDC (“K”) based on the received authentication data. As a result, mutual authentication of the switch (“X”) and Kerberos KDC (“K”) can be attained.

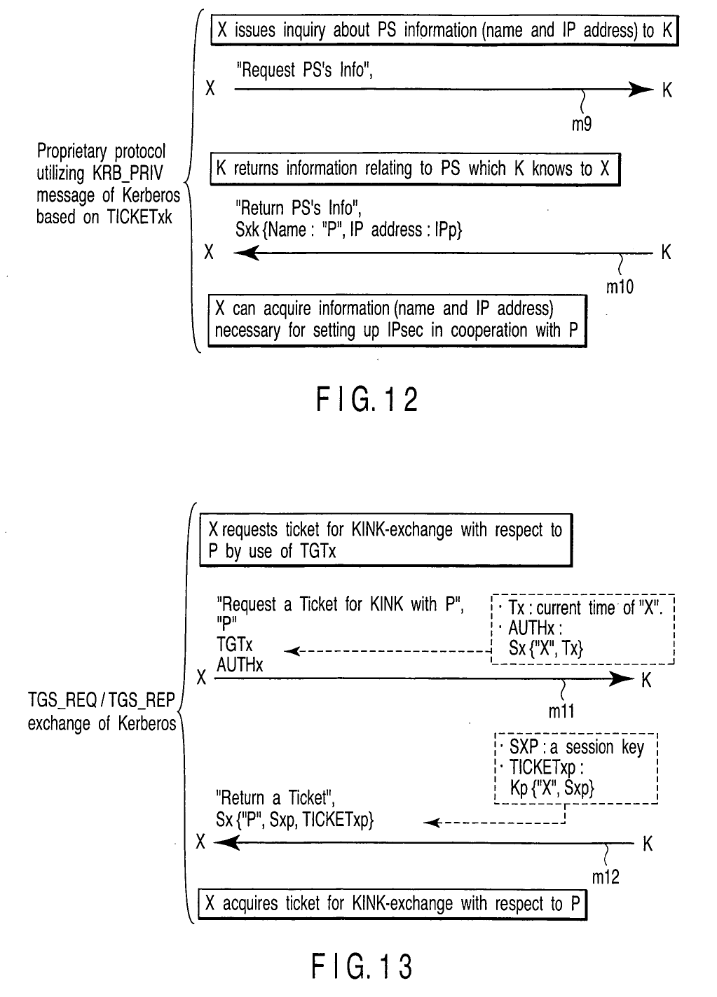

Then, as shown in FIG. 12, the switch (“X”) transmits a message m9 which makes an inquiry about property server information (name and IP address) to the Kerberos KDC (“K”) by use of its own protocol by using a KRB_PRIV message of Kerberos based on TICKETxk. In response to the message, the Kerberos KDC returns a message m10 indicating information relating to the property server which it knows to the switch (“X”). Thus, the switch (“X”) can acquire information (name and IP address) necessary for setting up IPsec in cooperation with the property server (“P”).

(Step S104: Registration of Self Information)

First, as shown in FIG. 13, in the TGS_REQ/TGS_REP exchange process of Kerberos, the switch (“X”) transmits a message m11 which requests a ticket for KINK-exchange with respect to the property server (“P”) to the Kerberos KDC (“K”) by use of TGTx. The switch (“X”) receives a message m12 as a reply and acquires the ticket for KINK-exchange with respect to the property server (“P”).

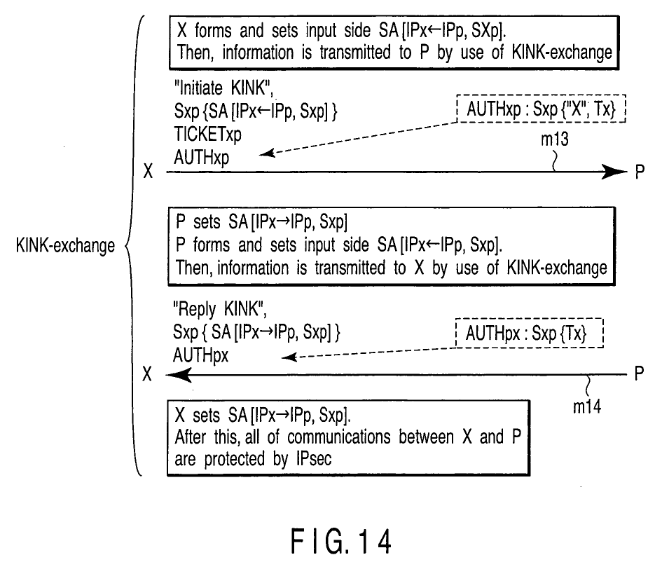

Next, as shown in FIG. 14, in the KINK-exchange process, the switch (“X”) forms and sets an input side SA[IPx←IPp, Sxp]. Then, it transfers the information to the property server (“P”) by use of a message m13 based on the KINK-exchange process. The property server (“P”) sets SA[IPx→IPp, Sxp]. Further, the property server (“P”) forms and sets an input side SA[IPx←IPp, Sxp]. Then, it transfers the information to the switch (“X”) by use of a message m14 based on the KINK-exchange process. The switch (“X”) sets SA[IPx→IPp, Sxp]. After this, all of the communications between the switch (“X”) and the property server (“P”) is protected by IPsec.

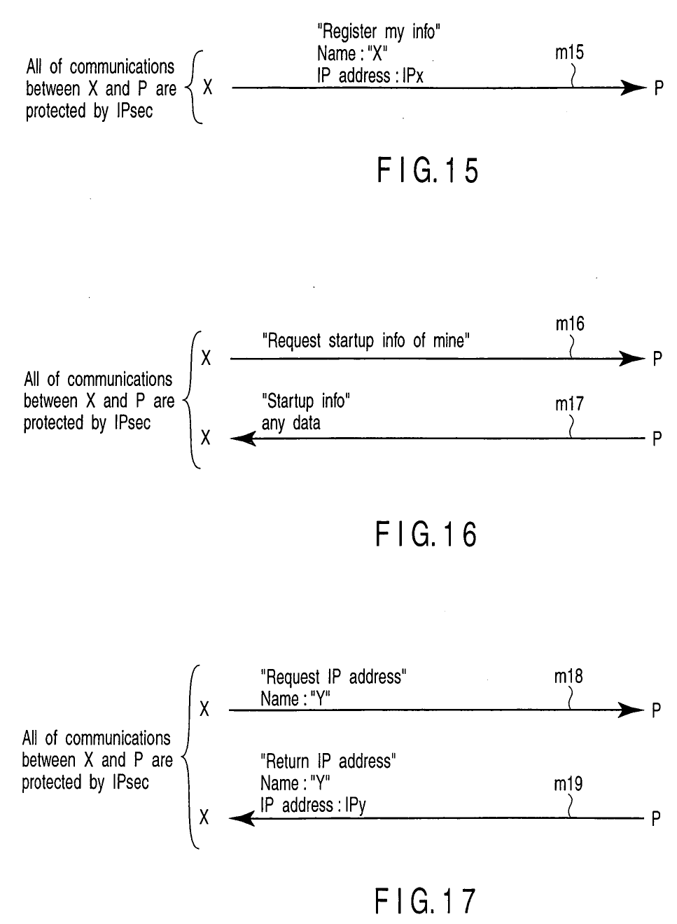

Then, as shown in FIG. 15, the switch (“X”) transmits a message m15 (“Register my info” Name: “X” IP address: IPx) which requests registration of self information to the property server (“P”). At this time, all of the communications between the switch (“X”) and the property server (“P”) is protected by IPsec.

(Step S105: Acquisition of Startup Information)

First, as shown in FIG. 16, the switch (“X”) transmits a message m16 (“Request startup info of mine”) which requests startup information to the property server (“P”). In response to the message, the property server (“P”) transmits a message m17 (“Startup info” any data”) indicating startup information to the switch (“X”). At this time, all of the communications between the switch (“X”) and property server (“P”) is protected by IPsec.

(Step S106: Acquisition of Partner Address)

First, as shown in FIG. 17, the switch (“X”) transmits a message m18 (“Request IP address” Name: “Y”) which requests an IP address of the illumination device (“Y”) which is a communication partner to the property server (“P”). In response to the message, the property server (“P”) returns a message m19 (“Return IP address” Name: “Y” IP address: IPy”) indicating an IP address of the illumination device (“Y”) to the switch (“X”). At this time, all of the communications between the switch (“X”) and property server (“P”) is protected by IPsec.

(Step S107: Desired Communication)

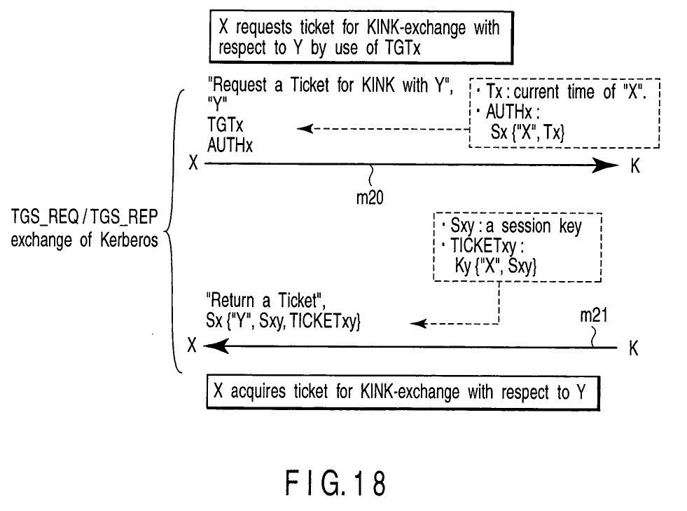

First, as shown in FIG. 18, in the TGS_REQ/TGS_REP exchange process of Kerberos, the switch (“X”) transmits a message m20 which requests a ticket for KINK-exchange with respect to the illumination device (“Y”) to the Kerberos KDC (“K”) by use of TGTx. The switch (“X”) receives and acquires a message m21 indicating a ticket for KINK-exchange with respect to the illumination device (“Y”) as a reply from the Kerberos KDC (“K”).

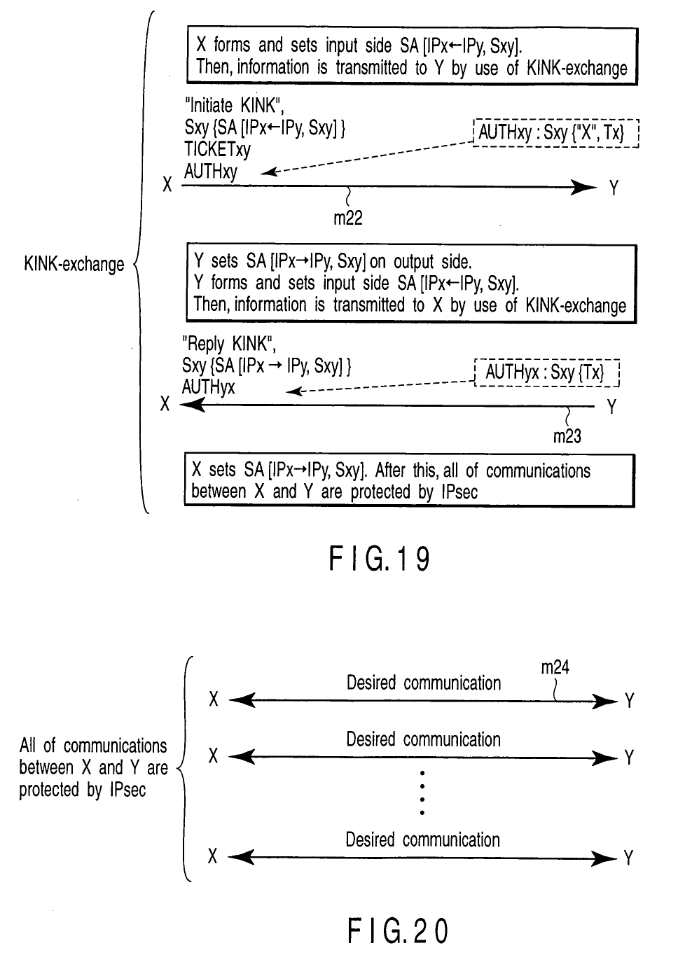

Next, as shown in FIG. 19, in the KINK-exchange process, the switch (“X”) forms and sets an input side SA[IPx←IPy, Sxy]. Then, it transfers the information to the illumination device (“Y”) by use of a message m22 based on the KINK-exchange process. The illumination device (“Y”) sets SA[IPx→IPy, Sxy] on an output side. Further, the illumination device (“Y”) forms and sets an input side SA[IPx←IPy, Sxy]. Then, it transfers the information to the switch (“X”) by use of a message m23 based on the KINK-exchange process. In response to the information, the switch (“X”) sets SA[IPx→IPy, Sxy]. After this, all of the communications between the switch (“X”) and the illumination device (“Y”) is protected by IPsec.

Then, as shown in FIG. 20, a desired message m24 is transferred between the switch (“X”) and the illumination device (“Y”).

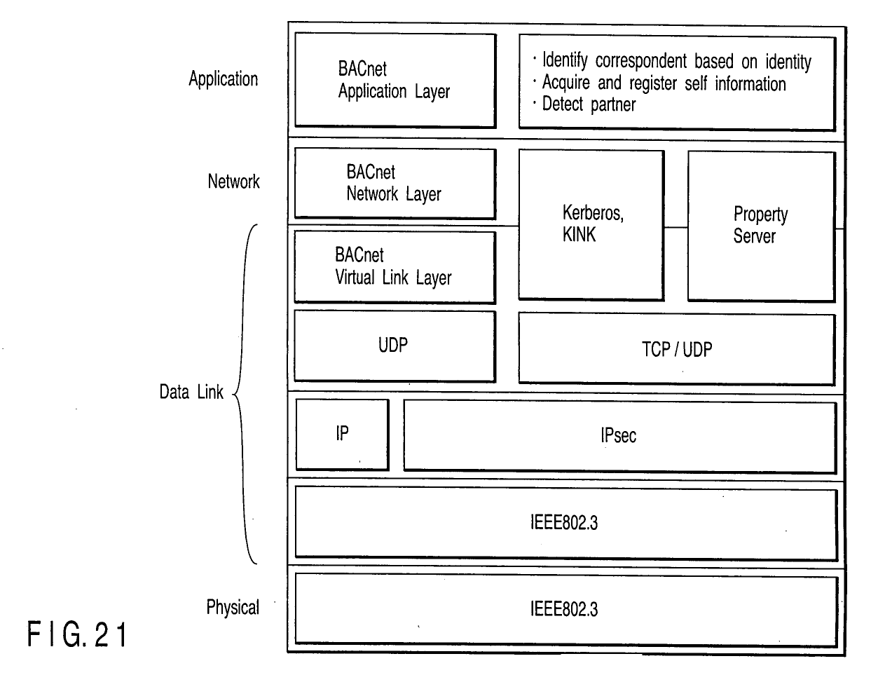

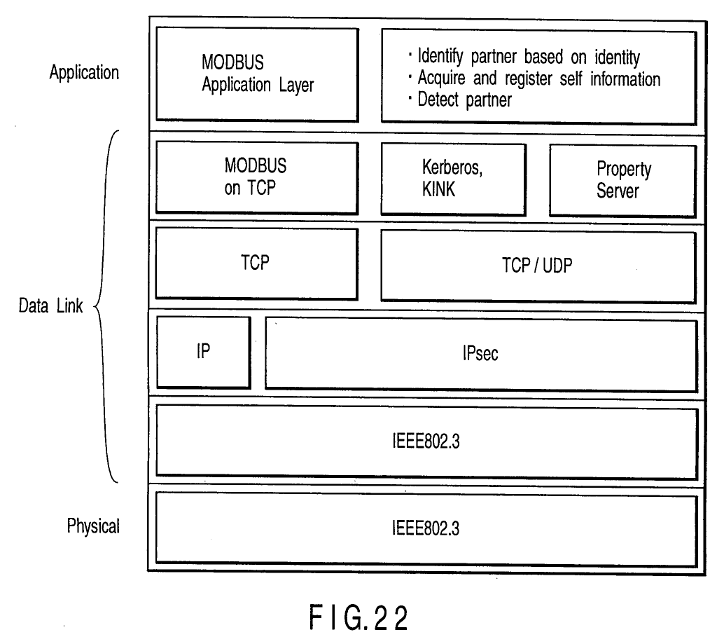

According to the second embodiment described above, a safe and autonomous setup of the device connected to the control network can be realized. Further, in order to utilize the present invention together with the existing IP-based control network, it is preferable to apply the present invention as follows. For example, as shown by an example of application to BACnet (trade mark) shown in FIG. 21 and an example of application to MODBUS TCP/IP (trade mark) shown in FIG. 22, some protocol hierarchies based on the IPsec shown in the above drawings are provided in a system in which an independent imaginary network layer is configured in the upper position of the IP layer. In this case, in the application layer, functions for embodying the present invention are expanded. For example, the functions include a function of identifying a communication partner by use of an identifier, a function of acquiring and registering self information, a function of detecting a communication partner and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method for setting network information of a first communication device when the first communication device is connected to a control network including a first server and a second server, comprising:
detecting the first server on the control network by the first communication device;
performing mutual authentication between the first communication device and the first server;
transferring, from the first server to the first communication device, key information necessary for security communication with respect to the second server, if the mutual authentication is successful;
identifying the second server by the first communication device on the control network; and
transferring the network information from the first communication device to the second server via the security communication using the key information; and
storing the network information in the second server so that the first communication device is initialized in the control network.

2. The method according to claim 1, wherein the network information includes property information represented by a network address and identifier of the first communication device.

3. The method according to claim 2, further comprising transmitting the property information of the first communication device from the second server to a second communication device when an inquiry about the identifier of the first communication device is issued from the second communication device.

4. The method according to claim 3, wherein the inquiry is made via security communication using key information which is necessary for security communication with respect to the second server and which the second communication device has acquired from the first server.

5. The method according to claim 1, wherein the first communication device detects the first server according to a DHCP service.

6. The method according to claim 1, wherein the first communication device detects the first server according to a multicast service.

7. The method according to claim 1, wherein the first server includes a key management server of Kerberos.

8. The method according to claim 7, wherein identifiers of the first and second communication device s are principals of Kerberos and the principals are used for mutual authentication.

9. The method according to claim 1, wherein the security communication includes IPsec and the first communication device exchanges security information with respect to one of the second server and second communication device according to a key exchange protocol of IPsec.

10. A network system comprising:
a control network including a first server and a second sever, the first server storing key information necessary for security communication with respect to the second server; and
a first communication device storing network information, and configured to:
detect the first server and the second server on the control network, when the first communication device is connected to the control network;
perform authentication with the first server in order to acquire the key information from the first server; and
transmit the network information to the second server via security communication using the key information,
wherein the network information is stored in the second sever so that the first communication device is initialized in the control network.

11. The system according to claim 10, wherein the network information includes property information represented by a network address and identifier of the first communication device.

12. The system according to claim 11, wherein the second server transmits the property information of the first communication device to a second communication device when an inquiry about the identifier of the first communication device is issued from the second communication device.

13. The system according to claim 12, wherein the inquiry is made via security communication using key information which is necessary for security communication with respect to the second server and which the second communication device has acquired from the first server.

14. The system according to claim 10, wherein the first communication device detects the first server according to a DHCP service.

15. The system according to claim 10, wherein the first communication device detects the first server according to a multicast service.

16. The system according to claim 10, wherein the first server includes a key management server of Kerberos.

17. The system according to claim 16, wherein identifiers of the first and second communication device s are principals of Kerberos and the principals are used for mutual authentication.

18. The system according to claim 10, wherein the security communication includes IPsec and the first communication device exchanges security information with respect to one of the second server and second communication device according to a key exchange protocol of IPsec.

19. A communication device connectable to a control network including a first server and a second server, wherein the first server stores key information necessary for security communication and the second server stores network information, comprising:
a storage to store network information to be stored in the second server;
a server detection unit to detect the first server and the second server on the control network;
a communication unit configured to:
perform authentication with the first server in order to acquire key information with respect to the second server;
transmit the network information to the second server via security communication using the key information, thereby to setup in the control network;
receive network information of another communication device from the second server;
receive key information necessary for security communication with respect to the another communication device from the first server; and
perform a desired communication with the another communication device via security communication using the key information with respect to the another communication device.

20. The communication device according to claim 19, wherein the first server is detected according to a DHCP service.

21. The communication device according to claim 19, wherein the first server is detected according to a multicast service.

22. The communication device according to claim 19, wherein the security communication includes IPsec and security information is exchanged with respect to one of the second server and another communication device according to a key exchange protocol of IPsec.
